(19) United States
(12) Patent Application Publication
(10) Pub. No.: US 2021/0192369 A1
(43) Pub. Date: Jun. 24, 2021

(54) METHOD FOR PREDICTING SHELF LIFE AND QUALITY OF FRUITS OR VEGETABLES

(71) Applicant: SOUTH CHINA BOTANICAL GARDEN, CHINESE ACADEMY OF SCIENCES, Guangzhou City, Guangdong (CN)

(72) Inventors: Hongxia QU, Guangzhou City (CN); Yijie ZHOU, Guangzhou City (CN); Zhongsuzhi CHEN, Guangzhou City (CN); Meiying HE, Guangzhou City (CN); Hong ZHU, Guangzhou City (CN); Ze YUN, Guangzhou City (CN); Ying WANG, Guangzhou City (CN); Yueming JIANG, Guangzhou City (CN)

(73) Assignee: South China Botanical Garden, Chinese Academy of Sciences, Guangzhou City, Guangdong (CN)

(21) Appl. No.: 16/978,203

(22) PCT Filed: Nov. 25, 2019
(86) PCT No.: PCT/CN2019/120543

§ 371 Date: Oct. 15, 2020

(30) Foreign Application Priority Data
Nov. 8, 2019 (CN) 201911090233.4

(51) Int. Cl. G06N 5/04; G06Q 10/08; G06Q 50/02; G06Q 30/02; A23B 7/00

(52) U.S. Cl. CPC G06N 5/04; G06Q 10/087; A23V 2002/00; G06Q 30/0202; A23B 7/00; G06Q 50/02

(57) ABSTRACT

A method for predicting the quality and shelf life of fruits or vegetables includes: recording ambient temperatures of the fruits or vegetables continuously using a temperature recorder from the beginning of plucking the fruits or vegetables and throughout entire supply chain including harvesting, grading, storage, transport and shelf period, determining an effective accumulated temperature value of the fruits during the entire supply chain, and predicting marketable fruit rate and nutritional quality of the fruits based on the effective accumulated temperature value. The marketable fruit rate, firmness and vitamin C content negatively correlate with the accumulated temperature value, and thus it is possible to predict the marketable fruit rate and storage quality of fruits based on the effective accumulated temperature values of the fruits or vegetables during the post-harvest storage and shelf period.

### CROSS REFERENCE TO THE RELATED APPLICATIONS

This application is the national stage entry of International Application No. PCT/CN2019/120543, filed on Nov. 25, 2019, which is based upon and claims priority to Chinese Patent Application No. 201911090233.4, filed on Nov. 8, 2019, the entire contents of which are incorporated herein by reference.

### TECHNICAL FIELD

The present invention relates to the field of horticulture, and particularly relates to a method for predicting the shelf life and quality of fruits or vegetables by using an accumulated temperature model.

### BACKGROUND

China is a big producer of fruits and vegetables, with a total production of over 1 billion tons, being the highest in the world; however, China suffers from severe post-harvest losses of up to 20% to 30%, causing an economic loss of more than 200 billion Yuan every year. Litchis and goji berries are famous fruits originating in China. In 2018 in China, the planting area for litchis reached 8.276 million mu (a unit of area used in China), with a production of 3.028 million tons and a comprehensive production value of 29.23 billion Yuan; however, while only 5.6% of the litchis were processed, these fruits are mainly sold, in fresh status, to north China or abroad. The planting area for goji berries reached about 3 million mu, with a production of 400 thousand tons of dry fruits and a comprehensive production value of 15 billion Yuan. At present, the farm prices of fresh goji berries are 20 to 25 Yuan/500 g, while the market prices (in Guangzhou) are 50 to 75 Yuan/500 g; thus, fresh berries have a market value much higher than that of dried berries, and have high economic benefits and good application prospects. However, compared with other fruits, fresh goji berries are still rare products. Due to the limitation of preservation and logistics technology, they can only be found in the markets of large cities such as Beijing, Shanghai, and Guangzhou, or the place where they are produced, greatly restricting the development of fresh berry market. Moreover, the storage and preservation of fresh goji berries not only affect the quality of fresh products, but also have important significance for reducing the rate of oil fruits (oil seeds) and improving the quality of dried berry products. In summary, due to intense post-harvest metabolism, litchis and fresh goji berries are highly perishable during storage and transport, resulting in severe post-harvest losses; the development and application of preservation technology for storage and transport of litchis and fresh goji berries are direct approaches for improving the economic benefits of their products.

Different fruits and vegetables have different nutritional quality and storage life, which are affected by internal and external factors, of which temperature and storage time are the most important factors affecting the storage quality of fruits and vegetables. Prediction of the nutritional quality and storage life of fruits and vegetables is of great significance for guiding the practice of preservation of fruits and vegetables during storage and transport.

### SUMMARY

One object of the present invention is to develop a method for predicting the quality and shelf life of fruits or vegetables, which makes it possible to predict the nutrient content changes and shelf life of litchis and fresh goji berries during postharvest storage, transport and shelf period, acting as a reference for the practice of preservation of other fruits and vegetables during storage and transport.

The method of the present invention for predicting the quality and shelf life of fruits or vegetables is characterized in that, it comprises: recording ambient temperatures of the fruits or vegetables continuously using a temperature recorder from the beginning of plucking the fruits or vegetables and throughout entire supply chain including harvesting, grading, storage, transport and shelf period, determining an effective accumulated temperature value (° C.·day or ° C.·hr) of the fruits stored for different periods of time (during the entire supply chain), and predicting marketable fruit rate and nutritional quality of the fruits based on the effective accumulated temperature values. Meanwhile, by measuring the marketable fruit rate, firmness, total soluble solids (TSS) content, and contents of nutrients such as vitamin C (Vc) and carotenoids, of the fruits or vegetables stored for different periods of time, the correlations between accumulated temperature and the quality indicators such as the marketable fruit rate, firmness, TSS content, and Vc content, can be analyzed.

Preferably, the fruits or vegetables are litchis, wherein when an effective accumulated temperature value during the entire supply chain is lower than or equal to 1,200° C.·h or 50° C.·day, the litchis are guaranteed to have high quality and a predicted marketable fruit rate is ≥95%.

Further preferably, the fruits or vegetables are litchis, wherein the marketable fruit rate and the vitamin C content in pulp negatively correlate with the effective accumulated temperature value.

Preferably, the fruits or vegetables are fresh goji berries, wherein when an effective accumulated temperature value during the entire supply chain is lower than or equal to 60° C.·day, the fresh goji berries are guaranteed to have high quality and a predicted marketable fruit rate is ≥95%.

Further preferably, the fruits or vegetables are fresh goji berries, wherein the marketable fruit rate and the firmness negatively correlate with the effective accumulated temperature value, while a zeaxanthin content positively correlates with the accumulated temperature value.

The inventors has discovered that, during the post-harvest storage and shelf period, the quality indicators of fruits, such as marketable fruit rate, firmness, and vitamin C content, negatively correlate with the effective accumulated temperature value, and therefore it is possible to predict the marketable fruit rate and nutritional quality of the fruits based on the effective accumulated temperature values of the fruits during the post-harvest storage and shelf period. Specifically, for litchis, the marketable fruit rate and the Vc content negatively correlate with the accumulated temperature value, wherein the recommended accumulated temperature value is lower than or equal to 1,200° C.·h or 50° C.·day. Under a condition of the recommended accumulated temperature value, the predicted marketable fruit rate can reach 95% or more, and the quality of the litchis can be guaranteed; for example, with a temperature of 10° C. for less than 5 days or a temperature of 5° C. for less than 10 days, the litchis are guaranteed to have high quality and a predicted marketable fruit rate is ≥95%. For fresh goji berries, the marketable fruit rate and the firmness negatively correlate with the accumulated temperature value, while the zeaxanthin content positively correlates with the accumulated temperature value, wherein the recommended accumulated temperature value is lower than or equal to 60° C.·day. Under a condition of the recommended accumulated temperature value, the predicted marketable fruit rate can reach 95% or more, and the quality of the fresh goji berries can be guaranteed; for example, with a temperature of 10° C. for less than 6 days or a temperature of 6° C. for less than 10 days, the fresh goji berries are guaranteed to have high quality and a predicted marketable fruit rate is ≥95%.

The beneficial effects of the present invention are as follows.

The inventors propose a method for predicting the marketable fruit rate and storage quality of fruits or vegetables based on the effective accumulated temperature values of the fruits or vegetables during the post-harvest storage and shelf period. According to the present invention, the marketable fruit rate, firmness and vitamin C content negatively correlate with the accumulated temperature value, and thus it is possible to predict the marketable fruit rate and storage quality of fruits based on the effective accumulated temperature values of the fruits or vegetables during the post-harvest storage and shelf period, which is of great significance and application value for guiding the practice of preservation of fruits and vegetables during storage and transport and reducing post-harvest losses of fruits or vegetables.

### BRIEF DESCRIPTION OF THE DRAWINGS

FIG. 1 shows the correlations between the marketable fruit rates and the accumulated temperature values of litchis “Gui-Wei” and “Nuo-Mi-Ci” in embodiment 1 with cold chain transport and a shelf period of 3 days under ordinary temperature.

FIG. 2 shows the changes in fruit appearance and total soluble solids (TSS) content in pulp of litchis “Gui-Wei” and “Nuo-Mi-Ci” in embodiment 1 with cold chain transport and a shelf period of 3 days under ordinary temperature.

FIG. 3 shows the correlations between the marketable fruit rates and the accumulated temperature values of litchis “Huai-Zhi” and “Nuo-Mi-Ci” in embodiment 1 with ordinary-temperature transport and a shelf period of 3 days under ordinary temperature.

FIG. 4 shows the change in vitamin C (Vc) content in pulp of litchis “Huai-Zhi” in embodiment 1 with ordinary-temperature transport and a shelf period of 3 days under ordinary temperature.

FIG. 5 shows the correlations between the marketable fruit rates and the accumulated temperature values of litchis in embodiment 1 when litchi varieties and transport types are comprehensively considered.

FIG. 6 shows the correlations between the marketable fruit rates and the accumulated temperature values of fresh goji berries in embodiment 2.

FIG. 7 shows the correlations between the fruit firmness and the accumulated temperature values of fresh goji berries in embodiment 2.

FIG. 8 shows the correlations between the zeaxanthin contents and the accumulated temperature values of fresh goji berries in embodiment 2.

### DETAILED DESCRIPTION OF THE EMBODIMENTS

The following embodiments are provided to further illustrate the present invention but not to limit the present invention.

### Embodiment 1: Method for Predicting Shelf Life and Quality of Litchi Fruits

1. Materials

Litchi varieties and degree of ripeness: Commercially harvested litchis “Gui-Wei”, “Nuo-Mi-Ci” and “Huai-Zhi”.

2. Method

The litchis were collected from Conghua region in Guangzhou. Litchi fruits, uniform in color and size, and free from pests, diseases, mechanical damages, and defects, were selected. Ambient temperatures were recorded from the beginning of plucking the fruits. The test was performed in two groups. For group I, the litchi fruits (without leaves) were pre-cooled in ice water for 5-10 minutes until the core temperature was low than or equal to 8° C., and packed in foam boxes (5 kg in each box) wherein two ice packs and one temperature recorder were provided inside each box which was then further packed in a paper box and transported by plane; at least three replicates for each litchi variety. For group II, the litchi fruits (with leaves) were packed in paper boxes with vents wherein one temperature recorder was provided inside each box (no pre-cooling step; no ice packs), and land transported under ordinary temperature; at least three replicates for each litchi variety. After the two groups of litchi fruits arrived in the destination city, the ambient temperatures were still recorded so as to determine the marketable fruit rates and the contents of total soluble solids (TSS) and vitamin C in pulp, and then the correlations between these quality indicators and accumulated temperature value were analyzed.

3. Results and Analysis

As shown in FIG. 1, during the cold chain transport and ordinary-temperature shelf period, the litchis “Gui-Wei” and “Nuo-Mi-Ci” exhibited negative correlations between the marketable fruit rates and the accumulated temperature values. Especially, the litchis “Gui-Wei” exhibited a significantly negative correlation between the marketable fruit rate and the accumulated temperature value, with a coefficient of correlation (R²) up to 0.997.

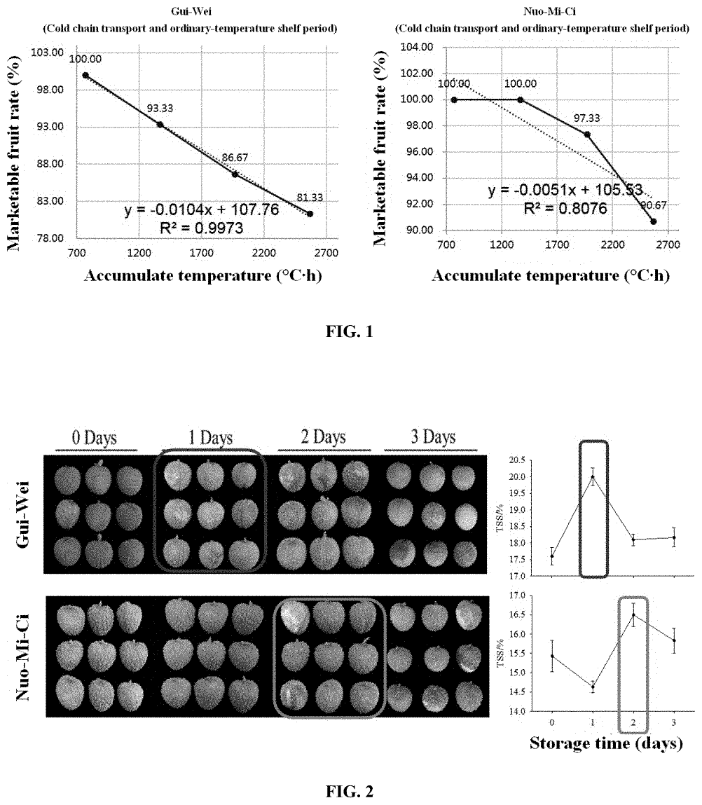

As shown in FIG. 2, during the cold chain transport and ordinary-temperature shelf period, the content of total soluble solids (TSS) of the litchis “Gui-Wei” increased at first but then decreased, while the TSS content of the litchis “Nuo-Mi-Ci” decreased at first but then increased. Such results indicate that, during the cold chain transport and ordinary-temperature shelf period, the TSS contents of litchis will increase or decrease without a regular pattern, and have no correlation with accumulated temperature values.

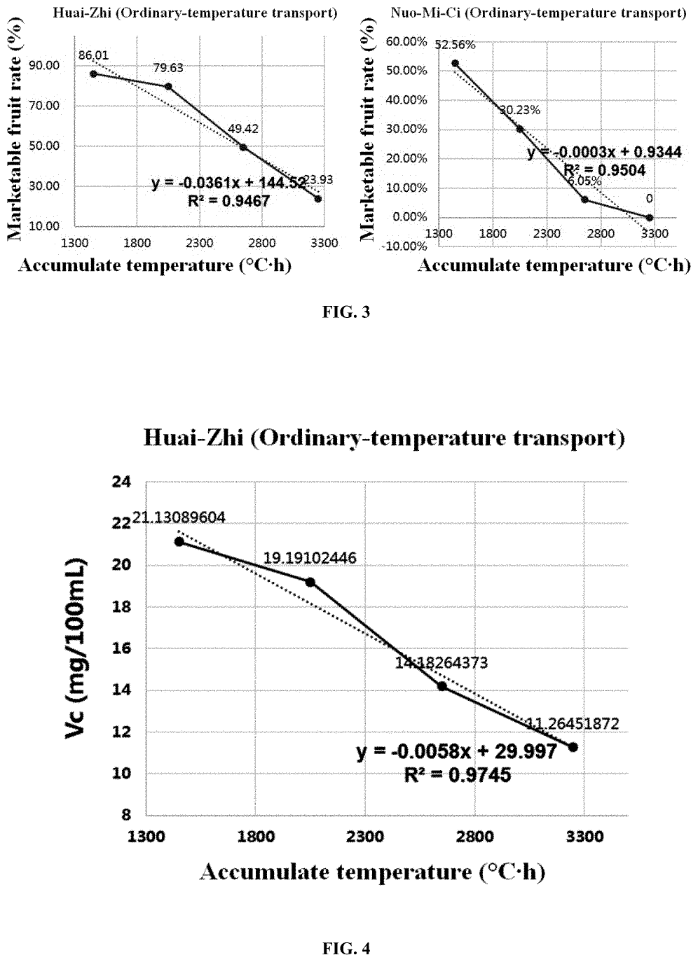

As shown in FIG. 3, during the ordinary-temperature transport and ordinary-temperature shelf period, the litchis “Huai-Zhi” and “Nuo-Mi-Ci” both exhibited negative correlations between the marketable fruit rates and the accumulated temperature values, with a coefficient of correlation (R²) of 0.947 and 0.950 respectively.

As shown in FIG. 4, during the ordinary-temperature transport and ordinary-temperature shelf period, the litchis “Huai-Zhi” exhibited a negative correlation between the vitamin C (Vc) content and the accumulated temperature value, with a coefficient of correlation (R²) of 0.947.

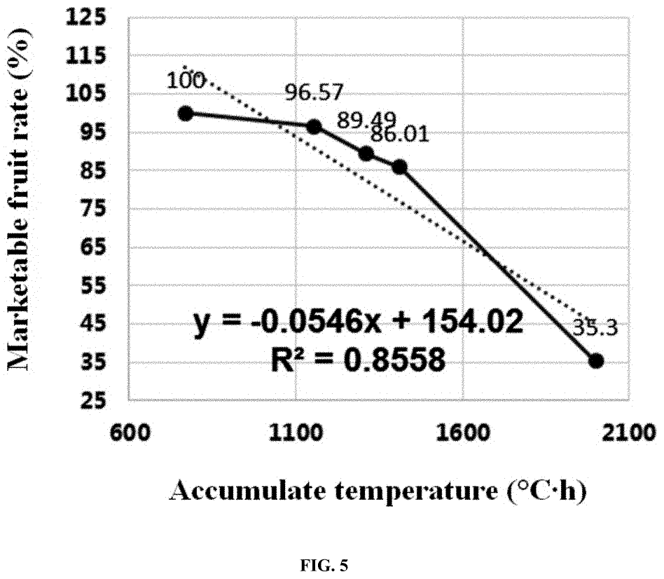

As shown in FIG. 5, regardless of whether it was “Gui-Zhi”, “Nuo-Mi-Ci”, or “Huai-Zhi”, and regardless of whether it was by cold chain transport or ordinary-temperature transport, the litchis exhibited a negative correlation between the marketable fruit rate and the accumulated temperature value.

It can be concluded from FIG. 1 to FIG. 5 that, for litchis, the marketable fruit rate and the Vc content negatively correlate with the accumulated temperature value, wherein the recommended accumulated temperature value is lower than or equal to 1,200° C.·h or 50° C.·day. Under a condition of the recommended accumulated temperature value, the predicted marketable fruit rate can reach 95% or more, and the quality of the litchis can be guaranteed; for example, with a temperature of 10° C. for less than 5 days or a temperature of 5° C. for less than 10 days, the litchis are guaranteed to have high quality and a predicted marketable fruit rate is ≥95%.

### Embodiment 2: Method for Predicting Shelf Life and Quality of Fresh Goji Berries

1. Materials

Fresh goji berry varieties and degree of ripeness: Commercially harvested fresh goji berries “Zhong-Ke-Lv-Chuan”.

2. Method

Fresh goji berries were collected. Ambient temperatures were recorded from the beginning of plucking the fruits. At the day the fruits were plucked, the fruits were transported to the laboratory wherein temperature recorders were provided inside the packages. The fruits were rinsed after they arrived at the laboratory. Fruits uniform in size and free from pests, diseases, mechanical damages, and defects, were selected. The selected fruits were air dried and then randomly put in plastic lunch boxes, 150 g in each box, totally ten boxes, which were then stored at 4° C. in a cold storage. The fruits were sampled every tree days for recording firmness, and sampled every week for determining marketable fruit rate and zeaxanthin content, wherein the zeaxanthin content was measured by high performance liquid chromatography (HPLC). In the end, the correlations between accumulated temperature value and various quality indicators such as marketable fruit rate, firmness and zeaxanthin content are analyzed.

3. Results and Analysis

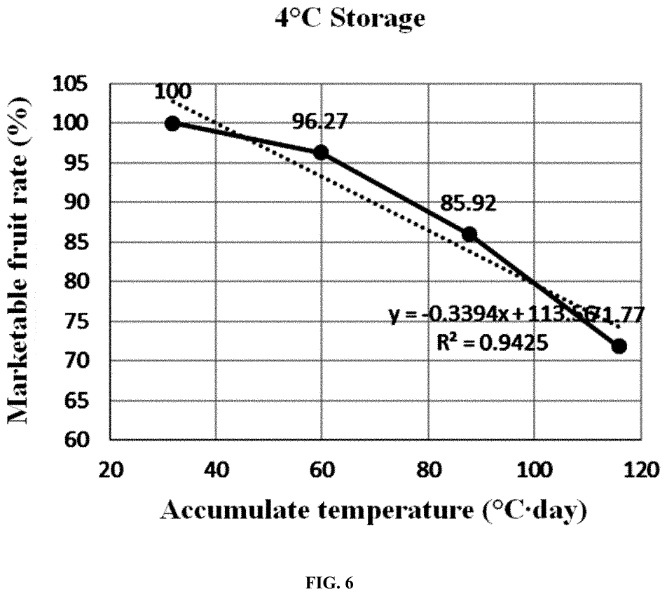

As shown in FIG. 6, the fresh goji berries exhibited a negative correlation between the marketable fruit rate and the accumulated temperature value, with a coefficient of correlation (R²) of 0.943.

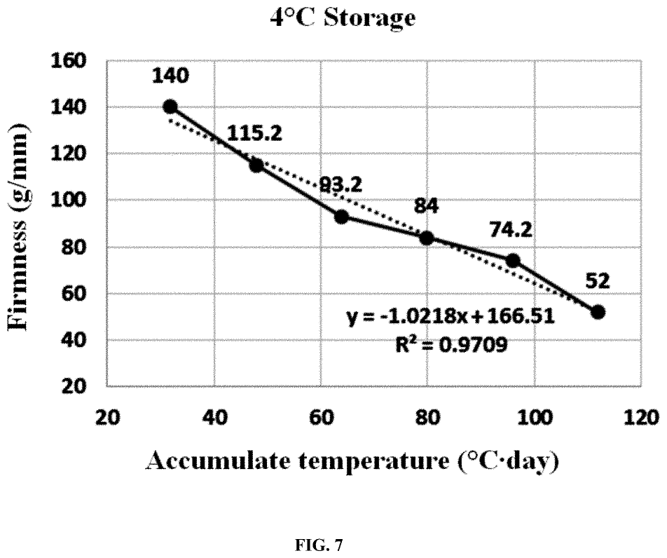

As shown in FIG. 7, the fresh goji berries exhibited a significantly negative correlation between the fruit firmness and the accumulated temperature value, with a coefficient of correlation (R²) of 0.971.

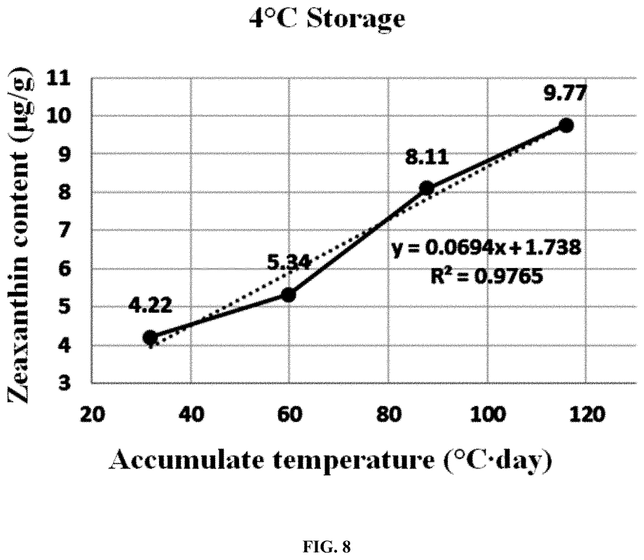

As shown in FIG. 8, the fresh goji berries exhibited a significantly positive correlation between the zeaxanthin content and the accumulated temperature value, with a coefficient of correlation (R²) of 0.977.

It can be concluded from FIG. 6 to FIG. 8 that, for fresh goji berries, the marketable fruit rate and the firmness negatively correlate with the accumulated temperature value, while the zeaxanthin content positively correlates with the accumulated temperature value, wherein the recommended accumulated temperature value is lower than or equal to 60° C.·day. Under a condition of the recommended accumulated temperature value, the predicted marketable fruit rate can reach 95% or more, and the quality of the fresh goji berries can be guaranteed; for example, with a temperature of 10° C. for less than 6 days or a temperature of 6° C. for less than 10 days, the fresh goji berries are guaranteed to have high quality and a predicted marketable fruit rate is ≥95%.

What is claimed is:

1. A method for predicting a quality of fruits, comprising: recording ambient temperatures of the fruits continuously by using a temperature recorder from a beginning of plucking the fruits or vegetables and throughout an entire supply chain comprising harvesting, grading, storage, transport and shelf period, determining an effective accumulated temperature value of the fruits during the entire supply chain, and predicting a marketable fruit rate and a nutritional quality of the fruits based on the effective accumulated temperature value.

2. The method according to claim 1, wherein the fruits are litchis, and the effective accumulated temperature value during the entire supply chain is lower than or equal to 1,200° C.·h or 50° C.·day.

3. The method according to claim 1, wherein the fruits are litchis, wherein the marketable fruit rate and a vitamin C content in a pulp negatively correlate with the effective accumulated temperature value.

4. The method according to claim 1, wherein the fruits are fresh goji berries, and the effective accumulated temperature value during the entire supply chain is lower than or equal to 60° C.·day.

5. The method according to claim 1, wherein the fruits are fresh goji berries, wherein the marketable fruit rate and a firmness negatively correlate with the effective accumulated temperature value, while a zeaxanthin content positively correlates with the effective accumulated temperature value.

6. The method according to claim 1, further comprising a step of maintaining the effective accumulated temperature value during the entire supply chain lower than or equal to a predetermined value so that the fruits have the marketable fruit rate ≥95%.

7. The method according to claim 6, wherein the fruits are litchis and the predetermined value is 1,200° C.·h or 50° C.·day.

8. The method according to claim 6, wherein the fruits are fresh goji berries and the predetermined value is 60° C.·day.
